(19) United States
(12) Patent Application Publication
(10) Pub. No.: US 2014/0274723 A1
(43) Pub. Date: Sep. 18, 2014

(54) COOLING DEVICE FOR A SUPERCONDUCTOR OF A SUPERCONDUCTIVE SYNCHRONOUS DYNAMOELECTRIC MACHINE

(71) Applicant: Siemens Aktiengesellschaft, Munchen (DE)

(72) Inventor: Markus Hösle, Erlangen (DE)

(21) Appl. No.: 14/351,438

(22) PCT Filed: Sep. 5, 2012
(86) PCT No.: PCT/EP2012/067324

§ 371 Date: Apr. 11, 2014

(30) Foreign Application Priority Data
Oct. 12, 2011 (DE) 10 2011 084 324.8

(51) Int. Cl. H02K 9/20; H02K 55/02; F17C 5/04

(52) U.S. Cl. CPC H02K 9/20; F17C 5/04; H02K 55/02
USPC 505/163; 62/47.1

(57) ABSTRACT

A cooling device for a superconductor, in particular a high-temperature superconductor of a synchronous machine includes a cooling circuit for a coolant, wherein the coolant liquefied in a cold head having a condenser is conveyed to the superconductor to be cooled, and is returned to the condenser in a gaseous state. In order to convey the coolant to the superconductor to be cooled, pressure is applied to the coolant.

The invention relates to a cooling device for a superconductor, in particular a high-temperature superconductor of a dynamoelectric synchronous machine, having a cooling circuit for a coolant, wherein the coolant which is liquefied in a cold head having a condenser is conveyed to the superconductor to be cooled and is returned to the condenser in a gaseous state.

The invention further relates to a superconducting dynamoelectric synchronous machine, in particular for use in airborne devices such as airplanes and helicopters, on seagoing vehicles or traction vehicles such as rail-borne vehicles or mining trucks.

Superconducting dynamoelectric synchronous machines have at least one superconducting winding, preferably in the rotor of the superconducting dynamoelectric synchronous machine. A so-called high-temperature superconductor (HIS superconductor) is often used in this case. HTS superconductors are metal-oxide superconductor materials having a transition temperature Tc higher than 77K.

Cryogenic liquids are used as coolants for the cooling of superconductors, including those in superconducting electric machines. For example, HTS superconductor cooling devices are known in which a coolant in the form of e.g. neon gas or nitrogen is liquefied at a cold head comprising a condenser in a closed system. From there, the coolant flows into the component containing the superconductor, e.g. a rotor to be cooled in a dynamoelectric synchronous machine. The coolant evaporating there reaches the condenser. The liquid coolant evaporates at a heat-conductive support which supports the superconductor, in particular at a winding support of the rotor, and flows back to the condenser in a gaseous state as a result of the pressure difference that is produced by the evaporation in the evaporator and the condensation in the condensation chamber of the condenser. The transport of the liquid coolant to the superconductor is effected by means of gravity in the case of known cooling devices. This inevitably means that the condenser is so arranged as to be geodetically higher than the evaporator, i.e. higher than the rotor. Overall, a closed cooling system is formed in this way.

This is also disclosed in EP 1 437 821 B1, for example, and essentially in JP 57095151 A.

This cooling method proves unreliable if an inclined position occurs in respect of this cooling device and/or the synchronous machine to be cooled, wherein this can easily occur during normal operation in the case of superconducting synchronous machines in aircraft, marine applications or traction vehicles. These synchronous machines are intended for use there as e.g. drives or generators in this case.

When using such means of transport, inclined positions arise as a result of e.g. gradients, curves, etc. In the event of such inclined positions, there is a danger according to the prior art that the liquid coolant no longer reaches the evaporator and the required cooling performance is no longer guaranteed.

Taking this as a starting point, the object of the invention is to specify a cooling device for a superconductor, in particular a superconducting dynamoelectric synchronous machine, which reliably transports the coolant to the superconductor to be cooled and maintains the cooling circuit without in this case being dependent on the gravitational effect and hence subject to the corresponding limitations during the operation of the dynamoelectric synchronous machine.

The stated object is achieved according to the invention by applying pressure to the coolant in order to convey the coolant into the superconductor to be cooled.

According to the invention, it is therefore proposed that the cooling device of the superconductor should be provided with a pressure which is at least sectionally effective in the section between the condenser and the superconductor to be cooled, and which is so configured in terms of operation that the coolant is subjected to pressure that conveys the coolant to the superconductor to be cooled. In this way, the liquid coolant can be conveyed to the superconductor to be cooled, in particular into the rotor of a superconducting synchronous machine, without the use of gravity and hence irrespective of the position of the condenser. In this case, use is made of the pressure of a mechanical spring or a gas spring, which in each case exerts a pressure onto the coolant via a plunger in a storage container and thereby conveys the coolant into the superconductor.

Such a supply of coolant to the superconductor is independent of the position of the cooling device and is therefore suitable for all types of use.

The quantity of liquid coolant can be determined in a flexible manner by means of the pressure, and the condenser no longer has to be arranged geodetically higher than the component to be cooled. A storage container for liquid coolant is provided in this case, said storage container being connected via a first line section to the condenser and via a second line section to the component which supports the superconductor to be cooled and acts as an evaporator, in particular the rotor, wherein the heat source is coupled to the storage container. Pressure is exerted on the liquid coolant in the storage container, such that the coolant is conveyed from the storage container to the superconductor.

This allows the second line section to be designed as a riser pipe. The coolant can therefore also be conveyed against gravity into the superconductor and the cooling circuit maintained thus.

Gravity does not therefore provide the force required to convey the coolant, and the second line section can now be at least sectionally flexible. Therefore this second line section need no longer comprise a rigid pipe, and can instead be designed as a corrugated hose through which the liquid coolant flows by virtue of the pressure in the storage container into the superconductor to be cooled.

In a further embodiment of the present invention, a valve is connected ahead of the storage container on the condenser side. In order to configure the layout in a particularly simple manner, said valve is a non-return valve in this case.

When it is in a closed state, the valve serves to direct the pressure, which is forced from the storage container into both line sections, into the second line section in the direction of the component to be cooled, i.e. the superconductor, in order to ensure effective cooling there.

It is obviously also possible in principle to use an electrically or hydraulically controlled valve in the line section on the condenser side.

If a non-return valve which exploits the gravitational forces is used, this non-return valve can preferably be arranged in the ascending part (adjacent to the storage container) of a siphon-like line section of the first line part. In this case, use is made of e.g. non-return valves which act on a load that is exposed to the gravitation, e.g. a ball or cone in the non-return valve. The line section to the storage container is therefore designed in the manner of a siphon and the non-return valve is arranged in the rising line part just ahead of the storage container.

In this case, a pressure which can be predetermined is exerted on the coolant in the storage container via a plunger by means of a mechanical spring or a gas pressure spring, and pushes the coolant via the second line section into the superconductor. The plunger provided for this purpose within the storage container moves between two limits of travel in particular, such that a cyclical operation of the cooling device 22 occurs during the course of operation without being necessarily regular.

In an appropriate embodiment, the cooling process can also be effected via a regulator, which operates as a function of the temperature at the superconductor and/or the fill level of the storage container in this case. Corresponding sensors are provided for this purpose, e.g. temperature sensors in the superconductor and/or fill-level sensors in the storage container and limit switches of the plunger, the data therefrom being supplied to a control device. This control device decides whether it is necessary to build up a corresponding pressure within the storage container by means of the plunger, or whether gas pressurization of the gas spring or tensioning of the spring is required.

It is of critical importance that the cooling device should be able to maintain the cooling circuit, even if the control device fails, for a time which can be predetermined. This requirement is satisfied because the pretensioned spring or gas spring, on account of its stored energy, is able to keep the coolant in the storage container under pressure and hence guarantee a cooling effect on the superconductor even if the control device fails.

In addition to the cooling device, the present invention also relates to a superconducting synchronous machine, in particular an FITS synchronous machine, primarily for use in airborne devices such as e.g. airplanes and helicopters, on seagoing vehicles and for traction devices in the context of road transport, rail transport or mining trucks featuring a cooling device according to the invention. The conveyance of the coolant within this cooling device and the superconductor to be cooled is largely independent of gravitational influences, and therefore the effects of inclined positions of the cooling device according to the invention in such means of transport are negligible in respect of its effectiveness. A dynamoelectric synchronous machine equipped with a cooling device according to the invention can therefore be used to particular advantage as a generator or motor in the vehicles cited above. The cooling device according to the invention can be used in these and in other applications in which conveyance caused by the gravitation may be unreliable due to possible inclined positions relative to gravity, and likewise in applications in which structural limitations prevent the realization of an arrangement wherein a condenser is higher than the rotor providing the evaporation chamber.

All of the remarks made in respect of the cooling device according to the invention can be applied analogously to the dynamoelectric synchronous machine according to the invention, which therefore likewise offers the cited advantages.

The invention and further advantageous embodiments of the invention are explained in greater detail with reference to schematic illustrations of exemplary embodiments, in which:

FIG. 1 shows a cooling device of a synchronous machine, and

FIG 2 shows a storage container of a cooling device.

FIG. 1 shows a schematic illustration of a cooling device 22 according to the invention, wherein said device is assigned to an electrodynamic synchronous machine 1 operating in a vehicle in order to cool superconducting windings 4 which are arranged within a rotor 5 that can rotate about an axis 3 relative to a stator 2. The windings 4 are made from a high-temperature superconductor and held by a thermally conductive winding support which is arranged in a vacuum housing and whose inner boundaries form an internal space that is essentially cylindrical and extends in an axial direction.

In this exemplary embodiment, neon gas is used as a coolant for cooling the superconductor in the rotor 5, said coolant moving in a closed cooling circuit. A coolant in a gaseous state is liquefied in a condensation chamber of a condenser 7 which is thermally connected to a cold head 6, this being thermally coupled to a refrigerating unit in a manner that is generally known. This liquid coolant is now routed via a first line section 8 into a storage container 12 and from there via a second line section 11 to the superconducting windings 4 in the rotor 5. The discharge of the liquid coolant into the rotor 5 takes place in a known manner in this case.

The cooling effect occurs because the coolant evaporates at the winding support and consequently cools the windings 4. The internal space of the rotor 5 therefore acts as an evaporation chamber in this respect. The coolant is routed back to the condenser 7 via a return line 9, where it is liquefied again.

Since the condenser can be so arranged as to be significantly lower geodetically than the rotor 5, and the second line section 11 is designed as a riser pipe, the gravitation is not used as a conveying force in the cooling device 22. In order to convey the liquid coolant through the second line section 11 into the rotor 5, use is instead made of a pressure in the storage container 12, said pressure being generated by a plunger 15.

As shown in FIG. 1, the first line section 8 ahead of the storage container 12 forms a siphon, wherein a non-return valve 10 is provided in that part of this first line section 8 which is adjacent to the storage container 12 and oriented against gravity. At the lower part of the storage container 12 in this illustration is arranged an apparatus which tensions a mechanical spring 19 or sets a gas spring to a pressure that can be predefined. During operation of the system, a pressure now acts on the liquid coolant contained in the storage container 12, and routes the liquid coolant through the second line section 11 into the internal space of the rotor 5. The path of the coolant directly back to the condenser 7 is closed automatically by the non-return valve 9 or by a gate which is not shown in further detail.

The build-up of the pressure in the storage container 12 takes place cyclically and is advantageously controlled by a control device 21. The control device 21 regulates the build-up and monitoring of the pressure and refers in this case to data from temperature sensors 16, 17, position sensors 13, 14 and fill-level sensors within the storage container 12. In this way, a cyclical operation of the control device 21 is established.

By virtue of a cyclical build-up of pressure via the pretensioned spring 19 or a gas spring, the cooling of the rotor 5 is guaranteed, even in the event of a failure of the electrical supply to the control device 21, for a time which can be predetermined.

The control device 21 can also be buffered by a battery or a capacitor in order to bridge a certain time period.

If a pressure is now built up in the pressure chamber 20 of the storage container 12 by means of operating the control device 21, the non-return valve 10 closes and liquid coolant is conveyed into the rotor 5. During a non-operating phase of the control device 21 or a relaxation of the pressure produced by the spring 19 or the gas spring, the non-return valve 10 can open and liquid coolant then flows onwards into the pressure chamber 20 of the storage container 12. Instead of the non-return valve 10, it is also possible to use a controlled valve which is likewise activated by the control device 21.

The second line section 11 is preferably so designed as to be sectionally flexible, e.g. having the form of a corrugated hose which is pressure resistant in particular, thereby aiding inter glia the spatial configuration and arrangement of the cooling device, particularly in the case of a restricted structural space.

FIG. 2 shows a storage container 12 having a reservoir 23 which is arranged between condenser 7 and non-return valve 10. The coolant flowing out of the condenser 7 flows into this reservoir 23 and remains there until it can flow onwards into the storage container 12. This occurs when the spring 19 is retensioned, for example. This onward flow generally takes place when the pressure in the storage container 12 is lower than that in the reservoir 23. An onward flow from the reservoir 23 via the non-return valve 10 to the storage container 12 is then possible. The condenser 7 is arranged geodetically above the reservoir 23 in this case.

Otherwise, the layout according to FIG. 2 does not differ from the cooling device and the layout according to FIG. 1.

What is claimed is:

1-9. (canceled)

10. A cooling device for a superconductor of a synchronous machine, comprising:
a cold head having a condenser for liquefying a coolant;
a cooling circuit for conveying the liquefied coolant to the superconductor to be cooled and returning the coolant to the condenser in a gaseous state; and
a pressure-application device configured to subject the coolant in the cooling circuit to a pressure as the coolant is conveyed to the superconductor, said pressure-application device having a storage container, a plunger received in the storage container, and a spring acting on the plunger to place the coolant under pressure in the storage container.

11. The cooling device of claim 10, wherein the superconductor is a high-temperature superconductor.

12. The cooling device of claim 10, wherein the spring is a mechanical spring or a gas spring.

13. The cooling device of claim 10, wherein the pressure-application device is configured to apply a pressure build-up in the storage container cyclically.

14. The cooling device of claim 10, wherein the pressure-application device is configured to regulate a pressure in the storage container in dependence on a temperature at the superconductor and/or a fill level of the storage container.

15. The cooling device of claim 10, wherein the storage container is disposed between the condenser and the superconductor, said coolant circuit having a first line section to connect the storage container with the condenser and a second line section to connect the storage container with the superconductor, with a pressure generation taking place in the storage container.

16. The cooling device of claim 15, wherein the second line section is embodied as a riser pipe.

17. The cooling device of claim 15, wherein the second line section has at least one flexible region.

18. The cooling device of claim 10, further comprising a valve or a reservoir connected upstream of the storage container at least on a side of the condenser.

19. The cooling device of claim 18, wherein the valve is a non-return valve.

20. The cooling device of claim 10, wherein the condenser is arranged so as to be geodetically lower than the superconductor.

21. A superconducting synchronous machine, comprising:
a superconductor; and
a cooling device including a cold head having a condenser for liquefying a coolant, a cooling circuit for conveying the liquefied coolant to the superconductor and returning the coolant to the condenser in a gaseous state, and a pressure-application device configured to subject the coolant in the cooling circuit to a pressure as the coolant is conveyed to the superconductor, said pressure-application device having a storage container, a plunger received in the storage container, and a spring acting on the plunger to place the coolant under pressure in the storage container.

22. The superconducting synchronous machine of claim 21, wherein the superconductor is a high-temperature superconductor.

23. The superconducting synchronous machine of claim 21, wherein the spring is a mechanical spring or a gas spring.

24. The superconducting synchronous machine of claim 21, wherein the pressure-application device is configured to apply a pressure build-up in the storage container cyclically.

25. The superconducting synchronous machine of claim 21, wherein the pressure-application device is configured to regulate a pressure in the storage container in dependence on a temperature at the superconductor and/or a fill level of the storage container.

26. The superconducting synchronous machine of claim 21, wherein the storage container is disposed between the condenser and the superconductor, said coolant circuit having a first line section to connect the storage container with the condenser and a second line section to connect the storage container with the superconductor, with a pressure generation taking place in the storage container.

27. The superconducting synchronous machine of claim 26, wherein the second line section is embodied as a riser pipe.

28. The superconducting synchronous machine of claim 26, wherein the second line section has at least one flexible region.

29. The superconducting synchronous machine of claim 21, wherein the cooling device includes a valve or a reservoir connected upstream of the storage container at least on a side of the condenser.

30. The superconducting synchronous machine of claim 29, wherein the valve is a non-return valve.

31. The superconducting synchronous machine of claim 21, wherein the condenser is arranged so as to be geodetically lower than the superconductor.

32. The superconducting synchronous machine of claim 21, for use in an airborne device selected from the group consisting of airplane and helicopter, or on a seagoing vehicles, or on traction vehicle.
